(19) United States
(12) Patent Application Publication
(10) Pub. No.: US 2009/0100703 A1
(43) Pub. Date: Apr. 23, 2009

(54) Clothes Dryer Utilizing an Air Source from the Exterior of a Structure

(75) Inventor: Daniel R. Blount, Sulphur Springs, TX (US)

Correspondence Address: BSH HOME APPLIANCES CORPORATION;INTELLECTUAL PROPERTY DEPARTMENT, 100 BOSCH BOULEVARD, NEW BERN, NC, 28562, US

(73) Assignee: BSH Bosch und Siemens Hausgeraete GmbH, Muenchen (DE)

(21) Appl. No.: 12/226,894

(22) PCT Filed: May 1, 2007
(86) PCT No.: PCT/US2007/010578

§ 371 Date: Oct. 31, 2008

Related U.S. Application Data
(63) Continuation-in-part of application No. 11/415,009, filed on May 1, 2006.

(51) Int. Cl. F26B 21/00; F26B 21/10; B23P 19/04; F24F 7/00; G05D 23/00

(52) U.S. Cl. 34/549; 34/72; 29/700; 454/237; 700/299

(57) ABSTRACT

A clothes drying system located in a structure, adapted to use air from outside the structure and thereby greatly reducing the energy required to air-condition the structure and run the dryer, has a dryer having an air intake port for taking the air into the dryer, and an air outlet port for expelling the air from the dryer. The clothes drying system further includes an air intake duct adapted to be operably attached to the air intake port and extend to outside the structure for transporting the air from outside of the structure to the dryer.

### BACKGROUND OF THE INVENTION

1. Field of the Invention

This invention relates generally to clothes dryers, and more particularly to a clothes dryer that is adapted to use air from outside a structure, thereby greatly reducing the energy required to air-condition the structure

2. Description of Related Art

Prior art dryers draw air from within the structure in which they are installed. A typical dryer uses air at a rate of about 200 cubic feet per minute. This air is then heated, used to dry the clothes, and then exhausted out of the structure with an air outlet duct. The air that is exhausted out of the structure is replaced with outside air, which leaks into the structure through cracks and other openings in response to the negative pressure, (vacuum), created by the dryer within the structure.

The problem with the prior art system is that modern structures, particularly homes, are almost always closely air-conditioned so that the air within the structure is maintained within a range of temperatures that is considered comfortable to the occupant. The outside air is often considerably hotter or colder than this air-conditioned inside air, and it costs a considerable amount of money and energy to accomplish this air-conditioning.

When a prior art dryer is operated on a hot day, for example, the air that has just been cooled by an air-conditioning system is taken into the dryer, heated back up to about 120 degrees, then used to dry the clothes. When this au is expelled, hot outside air flows into the house, further heating the house. The incoming air also functions to draw in dust, pollen, and other forms of outside pollutants.

The prior art teaches a dryer that draws air from within the structure in which it is installed, and then expels the air through an air outlet duct, resulting in a significant loss of energy and an introduction into the structure of dust, pollen, and outside pollution. However, the prior art does not teach a dryer that instead draws air from the outside of the structure, thereby conserving the air-conditioned air within the structure. Not only does this conserve a considerable amount of money and energy, it also preserves the integrity of the structure, excluding dust, pollen, and outside pollution. The present invention fulfills these needs and provides further related advantages as described in the following summary.

### SUMMARY OF THE INVENTION

The present invention teaches certain benefits in construction and use which give rise to the objectives described below.

The present invention provides a clothes drying system located in a structure. The clothes drying system is adapted to use air from outside the structure, greatly reducing the energy required to air-condition the structure and to run the dryer. The clothes drying system includes a dryer having an air intake port for taking the air into the dryer, and an air outlet port for expelling the air from the dryer. The clothes drying system further includes an air intake duct adapted to be operably attached to the air intake port and extend to outside the structure for transporting the air from outside of the structure to the dryer.

A primary objective of the present invention is to provide a clothes drying system having advantages not taught by the prior art.

Another objective is to provide a clothes drying system that draws air from outside the structure rather than from the interior of the structure, thereby avoiding a waste of the air-conditioned air within the structure, and further preventing non-conditioned air from being drawn into the structure when the conditioned air is pumped out of the structure.

Another objective is to provide a clothes drying system that reduces the energy necessary to run the dryer and also air-condition the structure.

Another objective is to provide a clothes drying system that draws air from an attic of the structure, simultaneously reducing the energy required by the dryer heater, and also ventilating the attic.

A further objective is to provide a clothes drying system that reduces the amount of dust, pollen, and outside pollutants drawn into the house by pumping air out of the structure.

Other features and advantages of the present invention will become apparent from the following more detailed description, taken in conjunction with the accompanying drawings, which illustrate, by way of example, the principles of the invention.

### BRIEF DESCRIPTION OF THE DRAWING

The accompanying drawings illustrate the present invention. In such drawings:

FIG. 1 is an perspective broken away view of a clothes drying system according to a first embodiment of the present invention;

FIG. 2 is an perspective broken away view of a second embodiment of the clothes drying system;

FIG. 3 is an perspective broken away view of a third embodiment of the clothes drying system;

FIG. 4 is a front elevational sectional view of a structure wherein the clothes drying system is installed, including a dryer installed inside the structure, an air intake duct installed to extend to an attic of the structure, and an air outlet duct installed to extend through a wall of the structure;

FIG. 5 is a front elevational sectional view of the structure of FIG. 4, wherein the air intake duct is installed to extend through the wall of the structure;

FIG. 6 is a side sectional view of the structure illustrating a prior art dryer; and

FIG. 7 is a side elevational view of a flexible or U-shaped conduit that includes a fastener for fastening the flexible or U-shaped conduit to a forward-facing air intake vent of the prior art dryer illustrated in FIG. 6.

### DETAILED DESCRIPTION OF THE INVENTION

The above-described drawing figures illustrate the invention, a clothes drying system 10 that includes a dryer 20 located in a structure 71, the dryer 20 functioning to dry clothes using air drawn from outside a structure 70, thereby conserving air-conditioned air located within the structure 70.

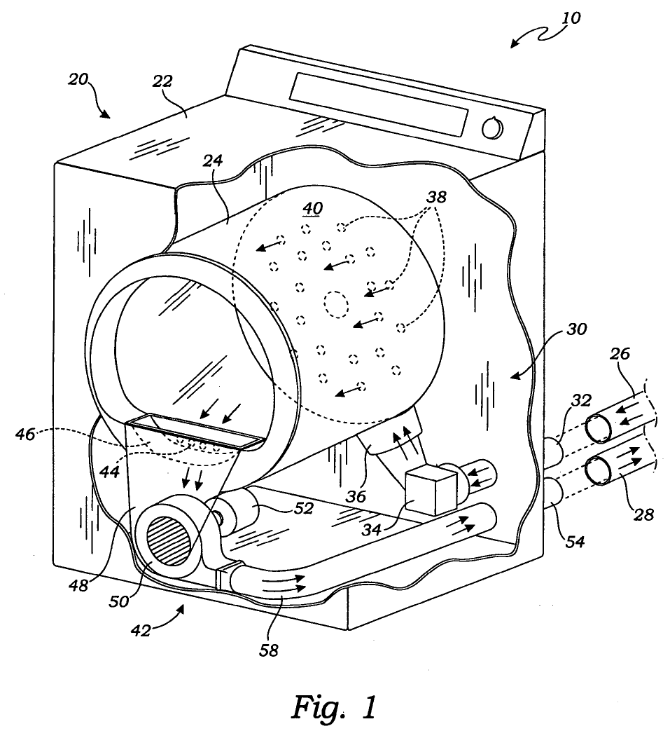

As shown in FIG. 1, the dryer 20 includes a dryer housing 22, a container 24 adapted for drying the clothes, and an air intake duct 26 that is adapted to extend from the dryer housing 22 to outside the structure 70. The clothes drying system 10 also includes an air intake system 30 adapted to receive the air from the air intake duct 26 and direct the air to the container 24 for drying the clothes.

The dryer housing 22 is substantially similar to the housings of prior art dryers, including a generally rectangular steel box for mounting and covering all of the various components of the dryer 20. The container 24 is also substantially similar to prior art dryers, preferably a cylindrical chamber that is mounted on a bearing (not shown) for rotation on a horizontal axis. The container 24 may also include a drying chamber, rack, or other structure known in the art for drying clothes. One alternative structure is disclosed in Meyer, U.S. Pat. No. 6,973,740, which is hereby incorporated by reference in full. Since these elements of the construction and function of the dryer 20 are substantially identical to the prior art, they are not described in detail herein, and these elements should be broadly construed to include all similar or equivalent structures, features, and alternatives.

FIG. 1 illustrates the critical improvement, which is the air intake duct 26 and the air intake system 30. Unlike the prior art, the air intake system 30 is adapted to draw air from the air intake duct 26, which is not included in the prior art. The air intake duct 26 is adapted to extend to outside of the structure 70 for using outside air for drying the clothes. In the preferred embodiment, the air intake duct 26 extends into an attic of the structure 70, as described in greater detail below.

The benefit of such a construction can be readily perceived on a hot day. Prior art dryers draw air from beneath the dryer 20, air which often will have just been cooled by an air conditioner, and beat the cool air with a heater 34, and then use this heated air to dry the clothes. The hot and moist air from the dryer 20 is then expelled from the house. The effect of pumping all of this inside air out of the house creates a negative pressure within the house which draws hot air into the house. At least some of the hot air drawn into the house comes in from the attic, which is usually particularly hot. This inefficient system puts a strain on the air conditioning of the structure 70, and results in a massive waste of energy.

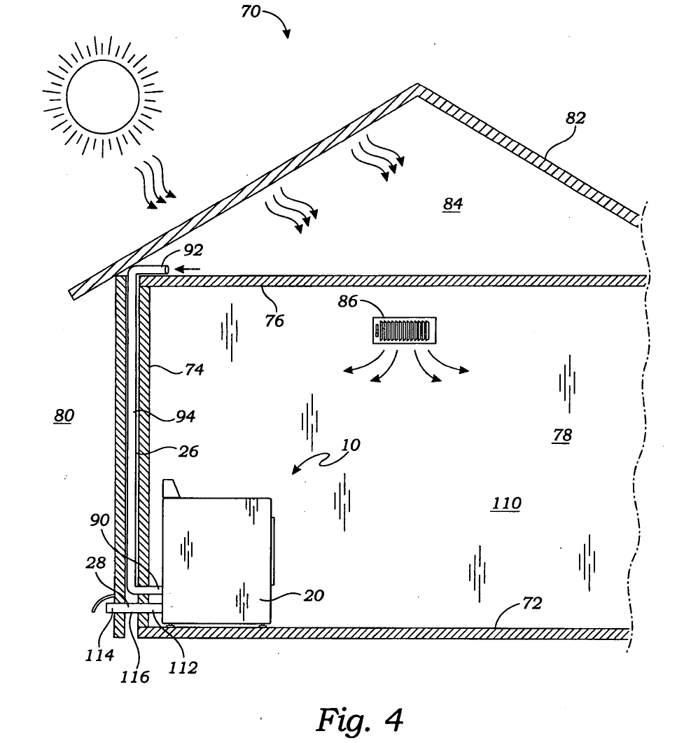

The clothes drying system 10 draws air from outside the structure 70 where the air is already hot. In the preferred embodiment, the air is drawn from the attic (element 84, illustrated in FIG. 4), which can often be over 120 degrees, which is greater than the heat required by the dryer 20. Rather than expelling the cool air from within the structure 70, the present clothes drying system 10 expels hot air from the attic, cooling the attic, while also potentially removing the need to heat the air in the dryer 20. All of these benefits and structures are described in greater detail below.

As shown in FIG. 1, the air intake system 30 preferably includes an air intake port 32 that is adapted to couple with the air intake duct 26. The term “air intake port” should be broadly construed to include any form of attachment coupling, joiner, connector, or intermediary that functions to join or otherwise operably associate the air intake duct 26 with the dryer 20 for operable transmission of the air from outside the structure 70. The air intake port 32, the air intake duct 26, the air outlet port 54, and the air outlet duct 28 may all be generally similar to the embodiment disclosed in Foco et al., U.S. Pat. No. 5,042,172, which is hereby incorporated by reference in full.

The air intake system 30 also preferably includes a heater 34. The air intake port 32 is preferably operably attached to, or in fluid communication with, the heater 34. While on some days the heater 34 may not be required, as described below, a heater 34 is preferably included for cooler days or nights. The operation of the heater 34 may be closely regulated, as disclosed in Heater et al., U.S. Pat. No. 6,199,300, which is hereby incorporated by reference in full.

The air intake system 30 preferably further includes a rear duct 36. The heater 34 is operably attached to, or in fluid communication with, the rear duct 36, which functions to direct the air to a plurality of holes 38 in a back wall 40 of the container 24. The term “plurality of holes” shall be broadly defined to include any form of holes, apertures, slots, or a single aperture otherwise shaped or structured to enable the air to flow into the container 24 without allowing clothes to become trapped by the air inlet. For example, a single aperture could be used if it were covered with a suitable grille, screen, or similar structure. An example of one embodiment of this structure is illustrated in Casey et al., U.S. Pat. No. 7,020,985, which is hereby incorporated by reference in full.

Once the air has passed through the container 24, drying the clothes in the container 24, the air exits the container 24 through an air outlet system 42 for venting the air from the container 24. The air outlet system 42 preferably includes exit apertures 44 that are similar to the plurality of holes 38, only the exit apertures 44 are preferably located at the front of the dryer 20, opposite the plurality of holes 38, for efficient ventilation of the container 24. The exit apertures 44 are preferably covered with a removable lint screen 46, as is well known in the art.

The air outlet system 42 preferably further includes a front duct 48 that connects the exit apertures 44 with a blower 50, and the blower 50 functions to propel the air through an exit duct 58 to an air outlet port 54. An air outlet duct 28 is adapted to be operably attached to the air outlet port 54 and extend to the exterior 80 of the structure 70 for transporting the air from the dryer 20 to outside of the structure 70. The air outlet port 54 is adapted to engage an air outlet duct 28 in generally the same manner as the air intake duct 26 engages the air inlet port. Since the air outlet system 42 is generally similar to the systems used in the prior art, it is not described in greater detail herein, and any alternative or equivalent systems used in the prior art are expressly defined as within the scope of the present invention.

The exit apertures 44 may also be formed through the back wall 40, as is illustrated in Casey et al., U.S. Pat. No. 7,020,985, which is hereby incorporated by reference in full. As will be apparent to one skilled in the art many of the elements described herein may be modified, reversed, or otherwise altered without changing the scope of the present invention, and such alternatives should be considered within the scope of the present invention.

The dryer 20 includes a blower 50 driven by a blower motor 52. The blower 50 may be positioned in other locations in the air flow path, and additional blowers, described below, may also be utilized to provide ample power for maintaining the system.

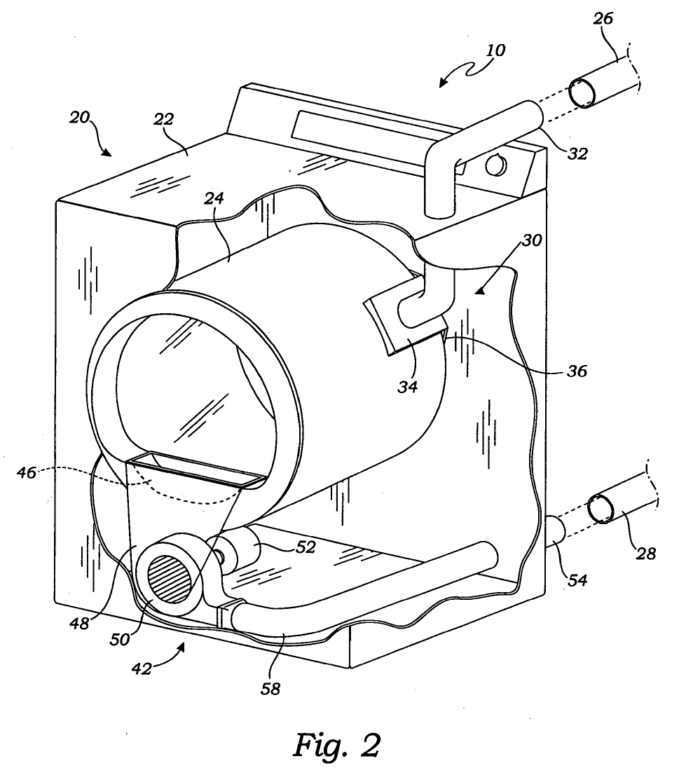

As shown in FIG. 2, the air inlet port is not required to be positioned at the back of the dryer 20. In an alternative embodiment, the air inlet port is located at the top of the dryer 20 to facilitate air movement through the dryer 20. The air inlet port could also be located at other locations, as could the air outlet port 54, for either improved ventilation or to ease installation of the dryer 20 in the structure 70.

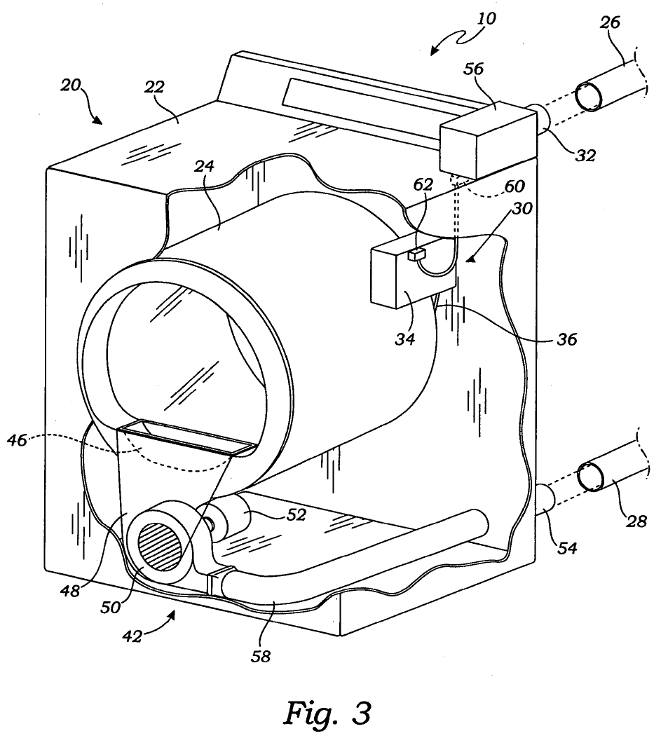

As shown in FIG. 3, a second blower 56 could also be installed at the air inlet port, as illustrated, or in another suitable location, for improving air flow through the clothes drying system 10. The second blower 56 may be helpful to maintain airflow through all of the additional ducting required by the clothes drying system 10. In the alternative, the single blower 50 could be used, as long as the blower motor 52 is strong enough to handle the demands of the clothes drying system 10.

Also, as shown in FIG. 3, the air intake system 30 further includes a temperature sensor 60 for sensing the temperature of the air as it enters the dryer 20, and a controller 62 for controlling the heater 34. The controller 62 responds to the temperature sensor 60 by either reducing the heat of the heater 34, or turning the heater 34 off entirely, when the temperature of the incoming air meets or exceeds a threshold temperature that is sufficient for drying the clothes, typically around 120 degrees Fahrenheit. This aspect of the invention is discussed in greater detail below.

FIG. 4 illustrates one embodiment of the dryer 20 installed in a structure 70. The structure 70, typically a home but which may be any form of building, enclosure, or similar edifice, includes a floor 72, walls 74, and a ceiling 76 that together define an interior 78. The structure 70 also defines an exterior 80 that is excluded from the interior 78 by the walls 74 and the ceiling 76. The structure 70 preferably also may include a roof 82 that defines an attic 84 between the ceiling 76 and the roof 82.

Typically, an air conditioner 86 (only a vent is illustrated) of the structure 70 provides cool air to the interior 78, and insulation in the walls 74 and the ceiling 76 maintain the cool air in the interior 78, while excluding the hot air in the exterior 80 and the attic 84. Insulation in the ceiling 76 is particularly important because the attic 84 tends to get very hot on sunny days, sometimes as high as 120 degrees, which is the operating temperature of many dryers.

In the embodiment of FIG. 4, a proximal end 90 of the air intake duct 26 is operably attached to the air intake port 32 of the dryer 20, the duct body 94 of the air intake duct 26 extends through the wall 74 (or, alternatively, the ceiling 76), and a distal end 92 of the air intake duct 26 is positioned within the attic 84. In this embodiment, the dryer 20 draws air from the attic 84 rather than the interior 78 of the structure 70. As noted above, the temperature of the air in the attic 84 can equal or exceed 120 degrees. On these occasions, the temperature sensor 60 and controller 62 (both shown in FIG. 3) may operate to turn off the heater 34, thereby saving additional energy in the drying process. Furthermore, the removal of the hot air from the attic 84 allows cooler air from outside the structure 70 to flow into the attic 84, further cooling the structure 70. Even on days when the attic 84 is not 120 degrees, it may be significantly warmer than the air in the interior 78 of the structure 70, thereby enabling the controller 62 to significantly reduce power to the heater 34, saving energy.

In the embodiment of FIG. 4, the air outlet duct 28 is also is also adapted to be operably attached to the dryer 20 and extend to the exterior 80 of the structure 70 for transporting the air from the dryer 20 to outside of the structure 70. This arrangement is common in the prior art because the hot, moist air, often contaminated with lint and other waste, must be vented to the exterior 80 of the structure 70 to prevent mold, lint buildup, and other problems associated with dryer exhaust. Since this structure is common in the prior art, it is not described in greater detail herein.

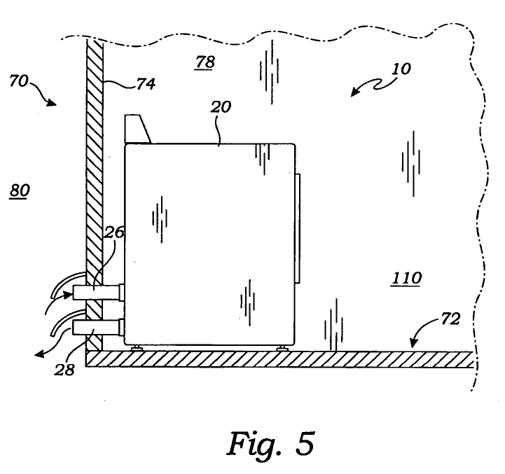

As shown in FIG. 5, the air intake duct 26 and the air outlet duct 28 may both be ventilated through the wall of the structure 70, rather than running the air intake duct 26 to the attic 84. While the attic 84 is presently preferred, there may be some embodiments when this configuration is not preferred. There may also be some situations when it is not possible, if the attic 84 is too far from the location of the dryer 20, or if the attic 84 is inaccessible for architectural reasons.

The dryer 20 of the present invention is notably different from prior art dryers 100, such as the prior art dryer 100 illustrated in FIG. 6. The prior art dryer 100 includes a forward-facing air intake vent that is adapted to take in the air from within the structure 70, most preferably under the front of the dryer (since there tends to be dust, lint, etc. behind the dryer, and this area is very difficult to clean).

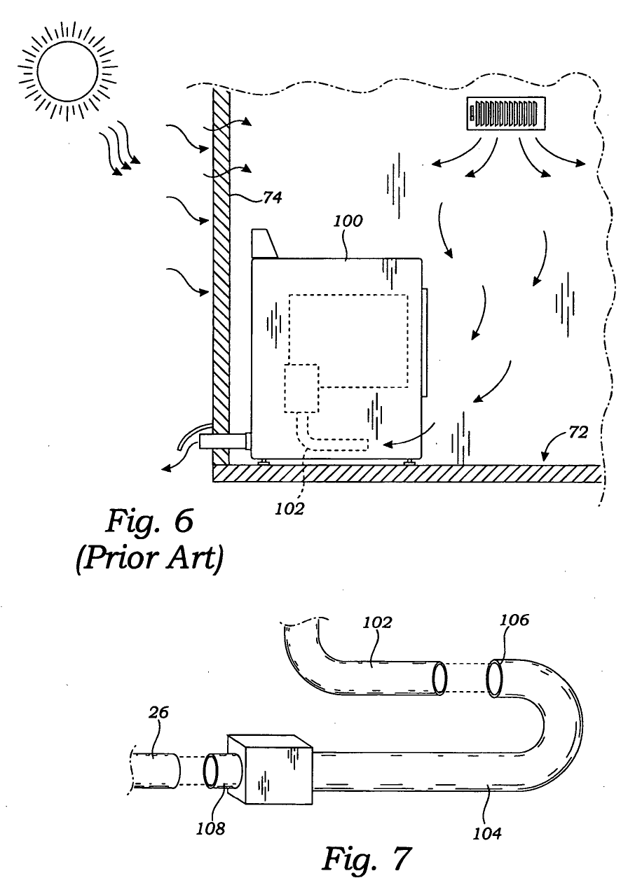

As shown in FIG. 7, the prior art dryer 100 may be adapted for use according to the teachings of the present invention with the addition of a flexible or U-shaped conduit to the air intake system 30. The flexible or U-shaped conduit includes a fastener for fastening the flexible or U-shaped conduit to the forward-facing air intake vent. The other end of the flexible or U-shaped conduit includes the air intake port 32 for attachment to the air intake duct 26.

The invention further includes a method for installing an air conduit network in a structure 70 for operating the above-described dryer 20. As shown in FIGS. 4-6, a dryer room is provided in the structure 70 where the dryer 20 is to be installed. The air intake duct 26, described in detail above, is installed in the structure 70 for venting the dryer 20 to the exterior 80 of the structure 70. The air intake duct 26 has a proximal end, a distal end, and a duct body that is long enough to extend from the dryer room to the wall 74. An air outlet duct 28 is also provided, having a proximal end, a distal end, and a duct body that is long enough to extend from the dryer room to the wall 74.

As shown in FIG. 4, the air intake duct 26 is installed through the structure 70 such that the proximal end is positioned in the dryer room for connection to the air intake port 32 of the dryer 20, and the distal end extends through the wall 74 of the structure 70 such that the air intake duct 26 draws air from outside of the structure 70. The distal end may extend to the attic 84, as shown in FIG. 4, or to the wall 74 of the structure 70, as shown in FIG. 5.

The air outlet duct 28 is also installed through the structure 70 such that the proximal end is positioned in the dryer room for connection to the air outlet port 54 of the dryer 20, and the distal end extends through the wall 74 of the structure 70 such that the air outlet duct 28 expels air outside of the structure 70 (see FIG. 4).

Once the dryer room has been prepared, the dryer 20, such as those shown in FIGS. 1-3, may be installed in the dryer room. The proximal end of the air intake duct 26 is operably connecting to the air intake port 32 of the dryer 20, and the proximal end of the air outlet duct 28 is operably connecting to the air outlet port 54 of the dryer 20.

Once installed, the dryer 20 functions to draw air from the exterior 80 of the structure 70, is preferably from the attic 84 which is exceptionally hot. Not only does this reduce the power necessary to heat the incoming air, it also does not pump the cool air out of the interior of the house. Cool air pumped out of the house is invariably replaced with hot air, which must then be re-conditioned, resulting in a tremendous waste of energy.

While the dryer 20 is an especially good energy saver during hot months, it is also an energy saver during the winter. While the heater 34 of the dryer 20 must work just as hard as with a prior art dryer 100, it still uses outside air rather than conditioned heated) interior air. Using outside air, rather than conditioned indoor air, avoids the need to heat cold outside air that leaks into the house due to air being pumped out of the house (as occurs with prior art dryers).

Finally, the dryer 20 of the present invention also reduces the amount of dust, pollen, and outside pollutants drawn into the house by prior art dryers. As the air from the exterior 80 of the house is pulled into the house to replace the air pumped out by a prior art dryer, it invariably draws in the dust, pollen, and other outside pollutants. The present invention removes this disadvantage by not pumping air out of the house, thereby allowing the house to maintain a more airtight quality, excluding dust, pollen, and other pollutants.

The terminology used in this application is hereby defined to include not only the words described above, but also similar or equivalent words, and derivatives thereof. Additionally, the words “a,” “an,” and “one” are defined to include one or more of the referenced item unless specifically stated otherwise. Also, the terms “have,” “include,” “contain,” and similar terms are defined to mean “comprising” unless specifically stated otherwise.

While the invention has been described with reference to at least one preferred embodiment, it is to be clearly understood by those skilled in the art that the invention is not limited thereto. Rather, the scope of the invention is to be interpreted only in conjunction with the appended claims.

1-16. (canceled)

17. A clothes drying system comprising:
a dryer having an air intake port, and an air outlet port; and
an air intake duct attached to the air intake port and extending to outside of a structure.

18. The system of claim 17, wherein an end of the air intake duct is in an attic of the structure.

19. The system of claim 18, further comprising an air outlet duct attached to the air outlet port and extending to the outside of the structure.

20. The system of claim 19, wherein the dryer further comprises a blower for circulating the air from the air intake duct to the air outlet duct.

21. The system of claim 20, wherein the dryer further comprises a heater for heating the air.

22. The system of claim 21, wherein the dryer further comprises a temperature sensor between the air intake port and the heater.

23. The system of claim 22, wherein the dryer further comprises a controller that controls the heater based upon the temperature sensed by the temperature sensor.

24. The system of claim 22, wherein the controller turns off the heater when the temperature sensor senses that the air entering the air intake port reaches a threshold temperature.

25. A dryer comprising:
a dryer housing having a container;
an air intake duct that extends from the dryer housing to outside of a structure; and
an air intake system that receives air from the air intake duct and directs the air to the container.

26. The dryer of claim 25, further comprising an air outlet system for venting the air from the container.

27. The dryer of claim 26, wherein the air outlet system comprises an air outlet port and an air outlet duct, the air outlet duct being attached to the air outlet port and extending to an exterior of the structure.

28. The dryer of claim 25, wherein the air intake system comprises an air intake port and a heater.

29. The dryer of claim 25, wherein the air intake system comprises a flexible or U-shaped conduit attached to a forward-facing air intake vent.

30. A method for installing an air conduit network in a structure for operating a dryer, the structure having a dryer room and a wall, the dryer having an air intake port and an air outlet port, the method comprising:
connecting an air intake duct that extends through the wall of the structure to the air intake port; and
connecting an air outlet duct that extends through the wall of the structure to the air outlet port of the dryer.

31. The method of claim 30, wherein the air intake duct extends into the attic.

32. An air intake duct comprising:
a proximal end that attaches to an air intake port of a dryer; and
a distal end that extends outside of a structure.

33. The duct of claim 32, wherein the proximal end comprises a conduit that attaches to a forward-facing air intake vent of the dryer.

34. A temperature controller for a dryer comprising:
a temperature sensor between an air intake port and a heater; and
a controller that controls the heater based upon the temperature sensed by the temperature sensor.

35. An air intake system comprising:
a proximal end of an intake duct that attaches to an air intake port of a dryer;
a distal end of the intake duct that extends outside of a structure;
a temperature sensor between the proximal end and a heater; and
a controller that controls the heater based upon the temperature sensed by the temperature sensor.

36. An air intake duct comprising:
a proximal end that attaches to an air intake port at the top of a dryer; and
a distal end that extends outside of a structure.
